(19) United States
(12) Patent Application Publication
(10) Pub. No.: US 2015/0214678 A1
(43) Pub. Date: Jul. 30, 2015

(54) Three-Plate Coaxial Connector

(71) Applicant: YUE SHENG EXACT INDUSTRIAL CO., LTD., New Taipei City (TW)

(72) Inventor: Chiu-Sheng Chen, New Taipei City (TW)

(21) Appl. No.: 14/519,111

(22) Filed: Oct. 20, 2014

(30) Foreign Application Priority Data
Jan. 24, 2014 (TW) 103201524

(51) Int. Cl. H01R 24/38

(52) U.S. Cl. CPC H01R 24/38

(57) ABSTRACT

A three-plate coaxial connector includes a base, a cover and a metal casing. The base includes a first electrically conductive plate buried in the base by a molding method, and the casing also includes a second electrically conductive plate buried in the casing by the molding method. The modular design of the three-plate coaxial connection reduces the level of difficulty and improves the convenience and efficiency in an assembling process. The first electrically conductive plate and the second electrically conductive plate have at least one first flap and at least one second flap respectively for improving the stability of a molding process. In addition, various positioning structures are designed at the base and the cover to enhance the positioning effect for the engagement while improving the accuracy and stability of the assembling process.

### CROSS-REFERENCE TO RELATED APPLICATIONS

This non-provisional application claims priority under 35 U.S.C. §119(a) on Patent Application No(s). 103201524 filed in Taiwan, R.O.C. on Jan. 24, 2014, the entire contents of which are hereby incorporated by reference.

### BACKGROUND OF THE INVENTION

1. Field of the Invention

The present invention relates to the field of connectors, and more particularly to a three-plate coaxial connector.

2. Description of the Related Art

In general, a coaxial connector is used extensively in electronic devices such as mobile communication devices, global positioning devices and notebook computers for connecting an antenna for transmitting high frequency signals. The coaxial connector comprises an accommodating hole formed in an insulating casing (or a plastic base) for connecting a center conductor protruded from the center of a coaxial plug, an external conductor (which is generally a metal casing) covered onto the exterior of the insulating casing, a fixed terminal and a movable terminal installed under the accommodating hole and contained in the insulating casing. In addition, an end of the fixed terminal has a contact portion, and an end of the movable terminal is fixed to the interior of the insulating casing, and the other end of the movable terminal is an elastic portion configured to be corresponsive to the center conductor and abutting the contact portion.

When the coaxial connector does not come with the coaxial plug, the movable terminal abuts the contact portion of the fixed terminal by the resilience of the elastic portion to keep the fixed terminal always be in an electric connection with the movable terminal. When the coaxial plug is plugged into the coaxial connector, a bottom end of the center conductor is inserted into the accommodating hole, so that a bottom end of the center conductor is abutted against the elastic portion and pressed to deform, and further separated from the contact portion. Therefore, the fixed terminal and the movable terminal are in an electrically disconnected status. In the meantime, the center conductor and the movable terminal are in an electrically connected status. As a result, a signal passing from the movable terminal to the fixed terminal and a signal passing from the movable terminal to the center conductor may be used for detecting whether or not a high frequency circuit connected to the coaxial plug and the movable terminal has any problem.

However, the movable terminal and the fixed terminal of most of the present coaxial connectors have a detachable design, and it is necessary to pay attention to the position after they are positioned during an assembling process in order to avoid unintentional electrical disconnections due to human negligence occurred during the assembling process, and thus most of the insulating casings are designed with a positioning structure for fixing the movable terminal and the fixed terminal, but the conventional structures still cannot overcome the issue of human negligence occurred during the assembling process, and these problems include the installation of the terminals in a wrong direction or the missing of components. Therefore, the conventional coaxial connectors require further improvements.

### SUMMARY OF THE INVENTION

In view of the aforementioned problems of the prior art, it is a primary objective of the present invention to provide a three-plate coaxial connector, wherein a first electrically conductive plate is buried into a base by a molding method, and a second electrically conductive plate is installed in a cover, so that after an assembler engages the cover with the base directly, the first electrically conductive plate abuts the second electrically conductive plate easily to reduce the level of difficult of the assembling process significantly and improve the convenience and efficiency of the assembling process. In addition, the first electrically conductive plate and the second electrically conductive plate have at least one first flap and at least one second flap respectively for improving the stability of the buried first and second electrically conductive plates. In addition, the present invention provides various positioning structures to improve the positioning effect of the engagement while improving the accuracy and stability of the assembling process significantly.

To achieve the aforementioned objective, the present invention provides a three-plate coaxial connector, comprising: a base, having a receiving slot formed at the center of the base, a positioning groove formed on a side of the receiving slot, a first electrically conductive plate buried into the other side of the receiving slot by a molding method and having a positioning surface formed thereon, wherein an end of the first electrically conductive plate has a first contact portion extending in a direction towards the receiving slot, so that the first contact portion is tilted upwardly and suspended in the receiving slot, and the other end of the first electrically conductive plate is extended to the exterior of the base to form a first soldering portion; a cover, having a sleeve protruded from the center of the cover, a second electrically conductive plate buried in the cover by a molding method, so that an end of the second electrically conductive plate is exposed from a side of the sleeve to form a second contact portion, and the other end of the sleeve being extended to the exterior of the cover to form a second soldering portion, and the cover having a positioning member protruded from a position corresponding to the second electrically conductive plate, and a side of the cover abutting the positioning surface, and the positioning member being inserted into the positioning groove, so that the cover is aligned precisely with and covered onto the base, and the first contact portion being pressed by the second contact portion to maintain a normally abutted status; and a metal casing, having a snap portion formed separately on both sides of the metal casing for snapping to two outer sides of the base to cover the cover therein, and the middle of the metal casing having a sheath portion configured to be corresponsive to the sleeve. Wherein, the base and the cover are made of an electrically insulating material by insert molding process.

In a preferred embodiment, the first electrically conductive plate is substantially a crossed plate structure with an end being bent to form the first soldering portion, and the other end in a symmetric direction forms the first contact portion, and at least one side of the first soldering portion has a first fixing flap provided for increasing the contact area for molding. The first fixing flap includes a plurality of first grooves formed on a surface of the first fixing flap to form the filling space for the molding process to improve the stability after the fixation. In addition, the second electrically conductive plate is substantially a T-shaped plate structure with a protrusion formed at the middle of the second electrically conductive plate being bent to form the second soldering portion, and at least one side of the second soldering portion has a second fixing flap provided for increasing the contact area during the molding process. The second fixing flap includes a plurality of second grooves formed on a surface of the second fixing flap to form the filling space for the molding process to improve the stability after the fixation.

In a preferred embodiment, the cover includes a positioning pillar disposed separately at four corners of the cover, and the top of the base includes four positioning holes formed at positions corresponsive to the positioning pillars respectively for inserting the positioning pillars into the positioning holes to improve the accuracy and stability of the assembling process. In addition, such arrangement prevents a wrong movement after the installation takes place.

In another preferred embodiment, the cover includes a protruding plate extended outwardly from a side corresponsive to the positioning surface, and the positioning surface includes a corresponding positioning notch for inserting the protruding plate therein to improve the accuracy and stability of the assembling process. In addition, such arrangement prevents a wrong movement after the installation takes place.

### BRIEF DESCRIPTION OF THE DRAWINGS

FIG. 1 is a first exploded view of a preferred embodiment of the present invention;

FIG. 2 is a second exploded view of a preferred embodiment of the present invention;

FIG. 3 is a cross-sectional view of a preferred embodiment of the present invention;

FIG. 4 is a schematic view of another implementation mode of a preferred embodiment of the present invention; and

FIG. 5 is a schematic view of a further implementation mode of a preferred embodiment of the present invention.

### DETAILED DESCRIPTION OF THE PREFERRED EMBODIMENTS

The aforementioned and other objectives, technical characteristics and advantages of the present invention will become apparent with the detailed description of preferred embodiments and the illustration of related drawings as follows.

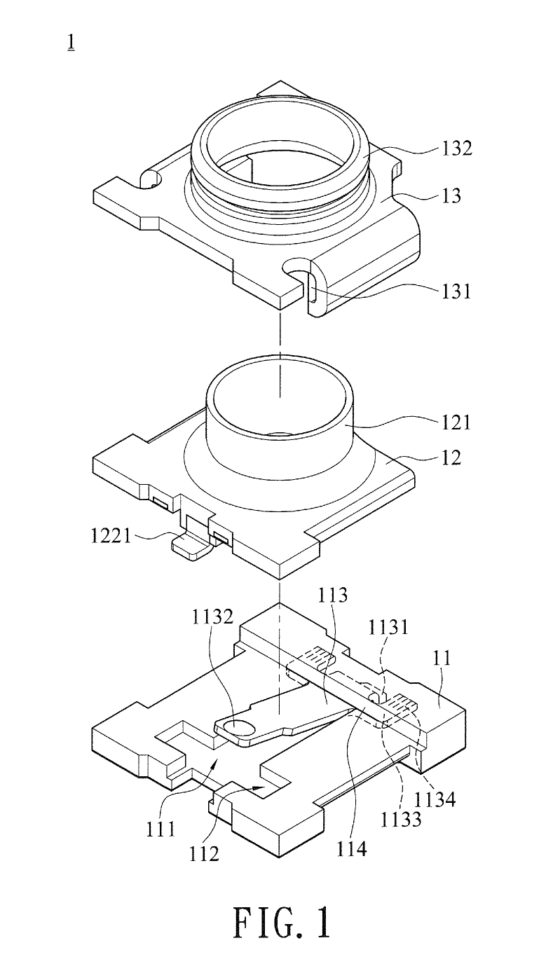

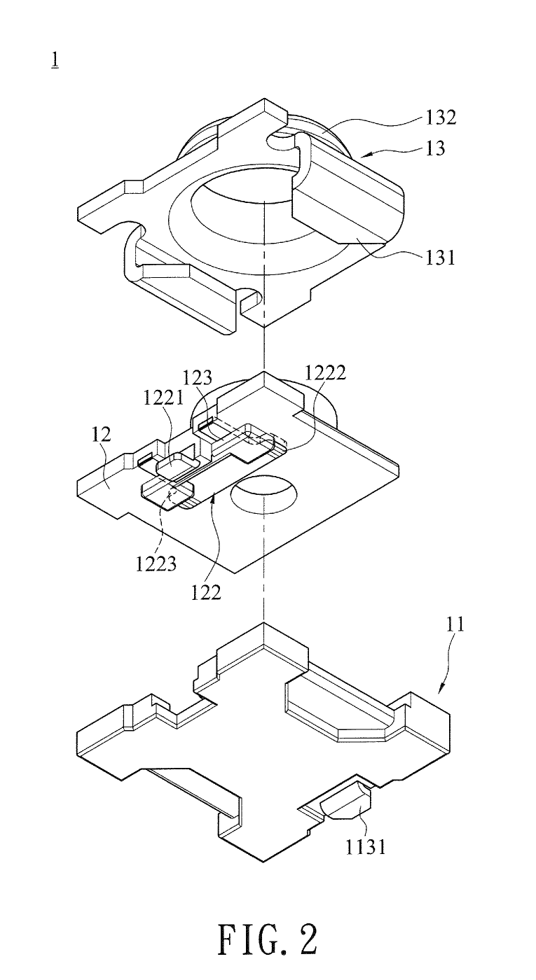

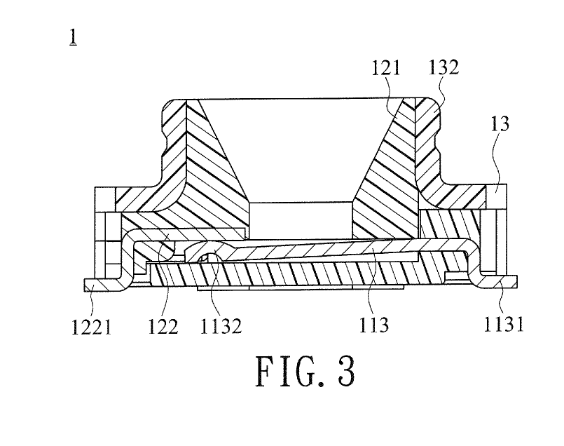

With reference to FIGS. 1 to 3 for exploded views and a cross-sectional view of a three-plate coaxial connector in accordance with a preferred embodiment of the present invention respectively, the three-plate coaxial connector 1 comprises a base 11, a cover 12 and a metal casing 13.

The base 11 is a rectangular plate made of an electrically insulating material by insert molding process, and a receiving slot 111 is formed at the center of the base 11 and a positioning groove 112 is formed on a side of the receiving slot 111, and a first electrically conductive plate 113 is buried into the other side of the receiving slot 111 by a molding method, and a positioning surface 114 is formed thereon, so that the positioning surface 114 and the positioning groove 112 are disposed symmetrically to each other. The first electrically conductive plate 113 is a cross-shaped plate structure made of a metal, and an end of the electrically conductive plate 113 is bent to form a first soldering portion 1131, and a first contact portion 1132 is formed at the other end of the electrically conductive plate 113 in a symmetrical direction. In addition, both sides of the first soldering portion 1131 have a first fixing flap 1133 separately, and the pair of first fixing flaps 1133 are provided for increasing the contact area during a molding process. In addition, both first fixing flaps 1133 have a plurality of first grooves 1134 formed on the surfaces of the first fixing flaps 1133 respectively to form a filling space during the molding process to improve the stability after the fixation. It is noteworthy that when the first electrically conductive plate 113 is buried in the base, the first contact portion 1132 is extended towards the receiving slot 111, so that the first contact portion 1132 is tilted upwardly and suspended in the receiving slot 111, and the first soldering portion is extended to the exterior of the base 11.

The cover 12 is a rectangular plate made of an insulating material, and a sleeve 121 is protruded from the center of the cover 12, and a second electrically conductive plate 121 is buried in the cover 12 by a molding method, wherein the second electrically conductive plate 121 is substantially a T-shaped plate structure and a protrusion at the center of the second electrically conductive plate 121 is bent to form a second soldering portion 1221, and both sides of the second soldering portion 1221 have a second fixing flap 1222 separately, and the pair of second fixing flaps 1222 are provided for increasing the contact area for the molding process, and the pair of second fixing flaps 1222 have a plurality of second grooves 1223 on the surfaces of the second fixing flaps 1222 respectively to fog the filling space for the molding process to improve the stability after the fixation. It is noteworthy that an end of the second electrically conductive plate 121 is exposed from a side of the sleeve 121 to form a second contact portion 1224, wherein the second soldering portion 1221 is disposed on the other side of the second contact portion 1224 and extended to the exterior of the cover 12. In addition, the cover 12 includes a positioning member 123 protruded from a position corresponding to the second electrically conductive plate 122.

When the cover 12 and the base 11 are assembled, a side of the cover 12 is abutted against the positioning surface 114, and the positioning member 123 is inserted into the positioning groove 112, so that the cover 12 is precisely aligned with and covered onto the base 11, and the first contact portion 1132 is pressed by the second contact portion 1224 to maintain a normally engaged status. In other words, an electric connection can be achieved after the first and second contact portions 1132, 1224 are soldered onto a substrate.

Both sides of the metal casing 13 are configured to be corresponsive to the base 11 and have a snap portion 131 separately for snapping to two outer sides of the base 11 to cover the cover 12 therein, and the center of the metal casing 13 is corresponsive to the sleeve 121 and includes a sheath portion 132 for covering the exterior of the sleeve 121.

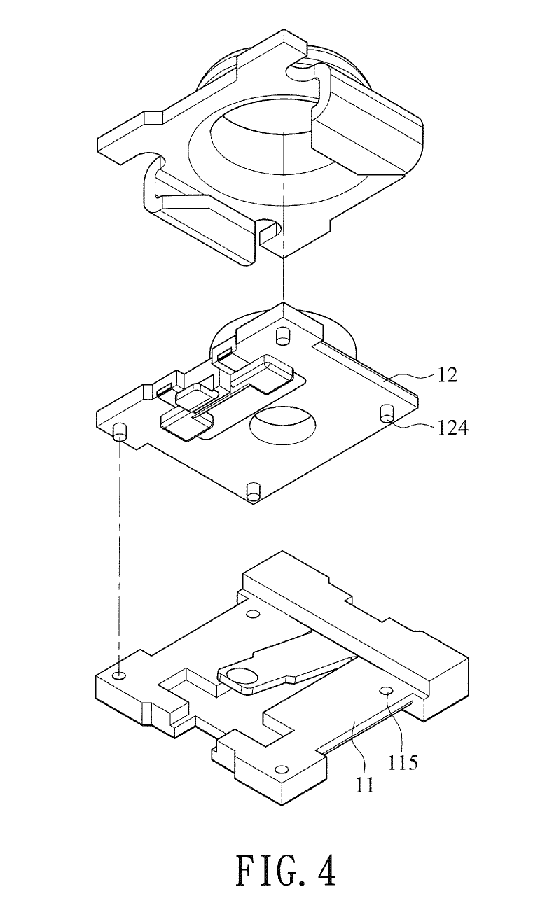

With reference to FIG. 4 for another implementation mode of a preferred embodiment of the present invention, a positioning pillar 124 is disposed at four corners of the cover 12 separately, and the top of the base 11 includes four positioning holes 115 formed at positions corresponding to the positioning pillars 124 respectively.

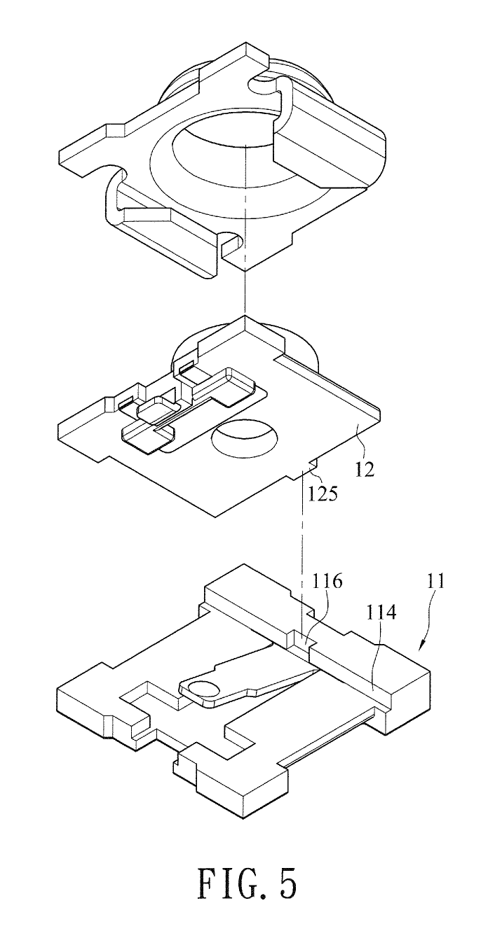

During the assembling process, the positioning pillars 124 are inserted into the positioning holes 115 respectively to define a positioning and fixing status and prevent a wrong movement during the application effectively, so as to improve the accuracy and stability of the assembling process. With reference to FIG. 5 for a further implementation mode of a preferred embodiment of the present invention, the cover 12 includes a protruding plate 125 extended outwardly from a side of the corresponding positioning surface 114, and the positioning surface 114 includes a positioning notch 116 for inserting the protruding plate 125 into the positioning notch 116. Both of the aforementioned methods can improve the structural strength, so as to enhance the durability and service life of the product.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A three-plate coaxial connector, comprising:
a base, having a receiving slot formed at the center of the base, a positioning groove formed on a side of the receiving slot, a first electrically conductive plate buried into the other side of the receiving slot by a molding method and having a positioning surface formed thereon, wherein an end of the first electrically conductive plate has a first contact portion extending in a direction towards the receiving slot, so that the first contact portion is tilted upwardly and suspended in the receiving slot, and the other end of the first electrically conductive plate is extended to the exterior of the base to form a first soldering portion;
a cover, having a sleeve protruded from the center of the cover, a second electrically conductive plate buried in the cover by a molding method, so that an end of the second electrically conductive plate is exposed from a side of the sleeve to form a second contact portion, and the other end of the sleeve being extended to the exterior of the cover to form a second soldering portion, and the cover having a positioning member protruded from a position corresponding to the second electrically conductive plate, and a side of the cover abutting the positioning surface, and the positioning member being inserted into the positioning groove, so that the cover is aligned precisely with and covered onto the base, and the first contact portion being pressed by the second contact portion to maintain a normally abutted status; and
a metal casing, having a snap portion formed separately on both sides of the metal casing for snapping to two outer sides of the base to cover the cover therein, and the middle of the metal casing having a sheath portion configured to be corresponsive to the sleeve.

2. The three-plate coaxial connector of claim 1, wherein the base and the cover are made of an electrically insulating material by insert molding process.

3. The three-plate coaxial connector of claim 1, wherein the first electrically conductive plate is substantially a crossed plate structure with an end being bent to form the first soldering portion, and the other end in a symmetric direction forms the first contact portion, and at least one side of the first soldering portion has a first fixing flap provided for increasing the contact area for molding.

4. The three-plate coaxial connector of claim 3, wherein the first fixing flap includes a plurality of first grooves formed on a surface of the first fixing flap to form the filling space for the molding process to improve the stability after the fixation.

5. The three-plate coaxial connector of claim 1, wherein the second electrically conductive plate is substantially a T-shaped plate structure with a protrusion formed at the middle of the second electrically conductive plate and being bent to form the second soldering portion, and at least one side of the second soldering portion has a second fixing flap provided for increasing the contact area during the molding process.

6. The three-plate coaxial connector of claim 5, wherein the second fixing flap includes a plurality of second grooves formed on a surface of the second fixing flap to form the filling space for the molding process to improve the stability after the fixation.

7. The three-plate coaxial connector of claim 1, wherein the cover includes a positioning pillar disposed separately at four corners of the cover, and the top of the base includes four positioning holes formed at positions corresponsive to the positioning pillars respectively for inserting the positioning pillars into the positioning holes to improve the accuracy and stability of the assembling process.

8. The three-plate coaxial connector of claim 1, wherein the cover includes a protruding plate extended outwardly from a side corresponsive to the positioning surface, and the positioning surface includes a corresponding positioning notch for inserting the protruding plate therein to improve the accuracy and stability of the assembling process.
